(19) United States
(12) Patent Application Publication
(10) Pub. No.: US 2017/0211763 A1
(43) Pub. Date: Jul. 27, 2017

(54) BEACON OBSTRUCTION LIGHTING SYSTEM

(71) Applicant: Whitebear Innovations Ltd., Boucherville, (CA)

(72) Inventors: Laird R. Daubenspeck, Medina, OH (US); David Bina, Northfield Center, OH (US)

(73) Assignee: Whitebear Innovations Ltd., Boucherville, QC (CA)

(21) Appl. No.: 15/330,189

(22) PCT Filed: Mar. 3, 2014
(86) PCT No.: PCT/CA2014/000183

§ 371 Date: Aug. 19, 2016

(51) Int. Cl. F21S 4/00; F21S 8/00

(52) U.S. Cl. CPC F21S 4/00; F21S 8/00; F21V 29/00

(57) ABSTRACT

A beacon for obstruction lighting (10) comprising a frame with a base (12) and a side, the side including a side wall (18) extending upwardly from the base with the side wall having at least one channel (26) formed therein and with a channel electric contact located proximate the channel, and an LED strip (28) having an LED electric contact (33) which is inserted in the at least one channel, and a cover (22) over the frame.

### FIELD OF THE INVENTION

The present invention relates to warning beacons and more particularly, relates to a beacon obstruction lighting system.

### BACKGROUND OF THE INVENTION

The use of obstruction lighting is well known in the art. Such obstruction lighting is typically used on towers, although the use thereof is also known at other locations such as airport runways and the like. Frequently, the use of beacons to warn of an obstruction comprises the use of a strobe lighting system. Typically, during the day, a white light is employed while during the night time hours, the intensity of the light can be lessened and a different color light such as red may be utilized.

There are other situations wherein lighting of a tower is not required during the daylight hours, but only during the night time hours. Typically, such towers are painted for visual warning during the daylight hours. The tower will typically have bands of red and white alternating areas.

For many years, incandescent lighting has been utilized since this was the only feasible commercial lighting. One of the problems with incandescent lighting is the operational cost. A typical setup will use two lamps of approximately 700 watts capacity for each. Naturally, the electricity cost can be substantial.

More recently, LED lights have started to be utilized. LED lights have two advantages—they reduce the operational cost substantially and their typical lifespan could be 10 years. Typically, the whole assembly is replaced at this point in time which again leads to a substantial cost.

One of the problems encountered with LED lighting is to design a lens which will have a very “tight” beam. The scattering of LED light can be substantial and the problem has existed of obtaining a narrow beam.

### SUMMARY OF THE INVENTION

It is an object of the present invention to provide a beacon warning system which is relatively inexpensive to operate and wherein the lifespan can be extended through use of replaceable LED lighting.

It is a further object of the present invention to provide an LED lighting system wherein the angle of the lighting is tightly controlled.

According to one aspect of the present invention, there is provided a beacon for obstruction lighting, the beacon comprising a frame, the frame having a base and a side, the side comprising a side wall extending upwardly from the base, the side wall having at least one channel formed therein, a channel electric contact located proximate the channel, a LED strip having an LED electric contact, the LED strip being inserted in the at least one channel, the LED electric contact being in electrical communication with the channel electric contact, the LED strip having least one LED thereon, and a cover.

According to a further aspect of the present invention, there is provided a lens for an LED utilized in a beacon, the lens having a length running in an X axis and width in a Y axis and a height in a Z axis, wherein the lens comprises a central portion, first and second side portions adjacent respective first and second sides of the central portion, the central portion having a convex cross sectional configuration in the direction of the X axis and a semi-circular configuration in the direction of the Y axis, the first side portion being located adjacent a first side of the central portion, the first side portion having an upwardly extending wall in the direction of the Z axis, the upwardly extending wall being located adjacent the first side of the central portion, the first side portion having a first top wall segment extending diagonally upwardly at a first angle with respect to a horizontal plane in the X axis, a second top wall segment extending diagonally upwardly adjacent to the first top wall segment, the second top wall segment having a second angle with respect to a horizontal plane in the direction of the X axis, the second angle being less than the first angle, the second side portion being a substantial mirror image of the first side portion.

The beacon, set forth above, includes a frame which will have a base and a side wall preferably mounted thereon. The side wall is arranged to hold LED strips. To this end, a preferred arrangement includes channels in the side wall with each channel preferably being designed to hold one LED strip.

Mounted proximate to each channel will be a channel electric contact for supplying power to the LED strip. In a preferred arrangement, the LED strip will have a LED electric contact located at the bottom thereon to mate with a channel electric contact located at the bottom of each channel. Upon insertion of the LED strip, the electrical contacts will automatically be aligned and electrical communication established.

The side wall will also act as a heat sink. To increase the heat capacity, a cover for the beacon may also function as a heat sink and to this end, the cover will be in contact with at least a portion of the frame.

The LED strips will include a plurality of LED's thereon, each LED will have a lens associated therewith as will be described in greater detail hereinbelow.

Preferably, each of the LED strips will include LED's of a differing color. Preferably, a majority of the LED's will be white since FDA regulations require a higher candela for the white lights. The remaining lights may be red for use at night.

For longevity, preferably the metallic components are anodized to minimize maintenance therefore.

### BRIEF DESCRIPTION OF THE DRAWINGS

Having thus generally described the invention, reference will be made to the accompanying drawings illustrating embodiments thereof, in which:

FIG. 1 is a perspective view of a beacon according to one aspect of the present invention;

FIG. 2 is a perspective view of a lens according to the present invention;

FIG. 3 is an end elevational view thereof;

FIG. 4 is a side elevational view thereof;

FIG. 5 is a top plan view thereof;

FIG. 6 is a plan view of an LED lighting strip having only a single LED and lens mounted thereon;

FIG. 7 is a plan view illustrating a full LED lighting strip;

FIG. 8 is an expanded detailed view showing the electrical contact at one end thereof; and

FIG. 9 is a top plan view of the beacon with a portion of the cover cutaway.

### DETAILED DESCRIPTION OF THE INVENTION

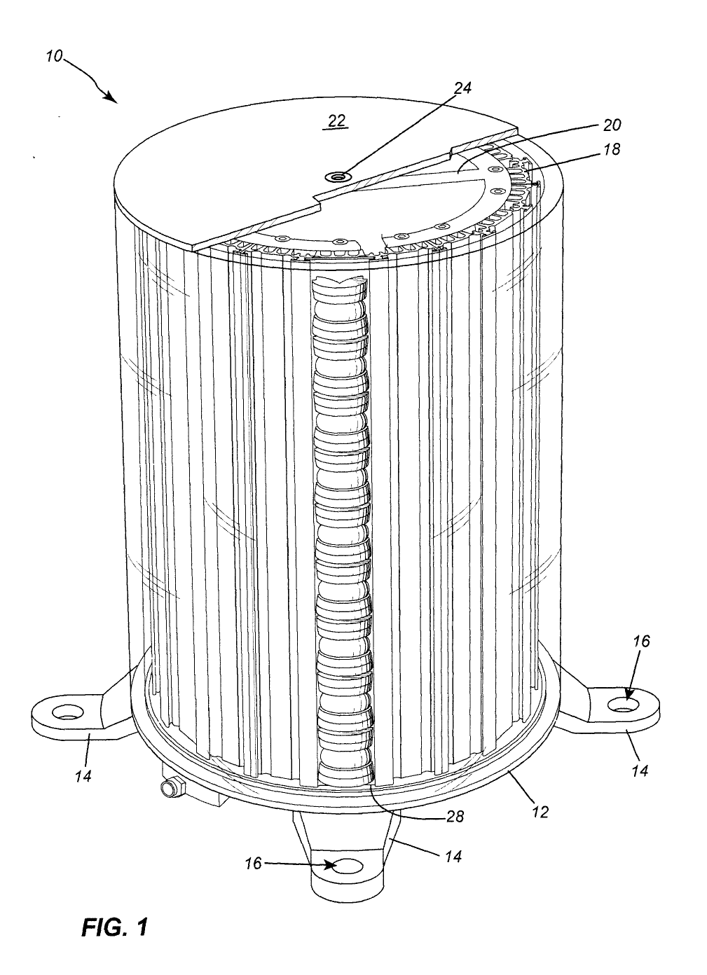

Referring to the drawings in greater detail and by reference characters thereto, the beacon of the present invention is shown in FIG. 1 and generally designated by reference numeral 10.

Beacon 10 has a base 12 with a plurality of legs 14 extending outwardly therefrom. Each leg has an aperture 16 for mounting the same onto a tower with suitable mounting means (not shown).

The frame of the beacon includes the base 12 and a side wall 18. Side wall 18 is circular in configuration and there is provided a transverse member 20. A cover 22 is secured to transverse member 20 by attachment member 24. Side wall 18 is fabricated of members which have a plurality of channels 26 formed therein. Each channel 26 is designed to receive a LED lighting strip which can be inserted from the top and slid within a respective channel 26. LED lighting strips 28 have a plurality of LED's (including lens) 30 formed thereon. Flanges 32 formed adjacent channels 26 serve to retain the LED lighting strips 28 in position. LED lighting strips utilize connecting wire 31 which terminates in connector 33.

It will be noted that each of the members forming side wall 18 have a plurality of inwardly extending ribs 34 which act as a heat sink. Cover 22 likewise will act as a heat sink by contact with the frame.

Each LED has a lens 40 associated therewith. Lens 40 is designed to maintain a narrow beam of light which is required under FAA regulations in the United States. The design is such that one may maintain a minimum 20,000 candela while maintaining under ±10% beam spread from the horizontal plane. One arrangement utilizes a minimum of five white LED's per strip and a minimum of two red LED's per strip. In the illustrated embodiment, there are preferably 18 strips per beacon.

Each strip will normally run at 1.3 amps of current with a total power consumption of 387 watts when operating in white mode. When operating in red mode, the strips will only draw 0.5 amps and have a total power consumption of 53 watts.

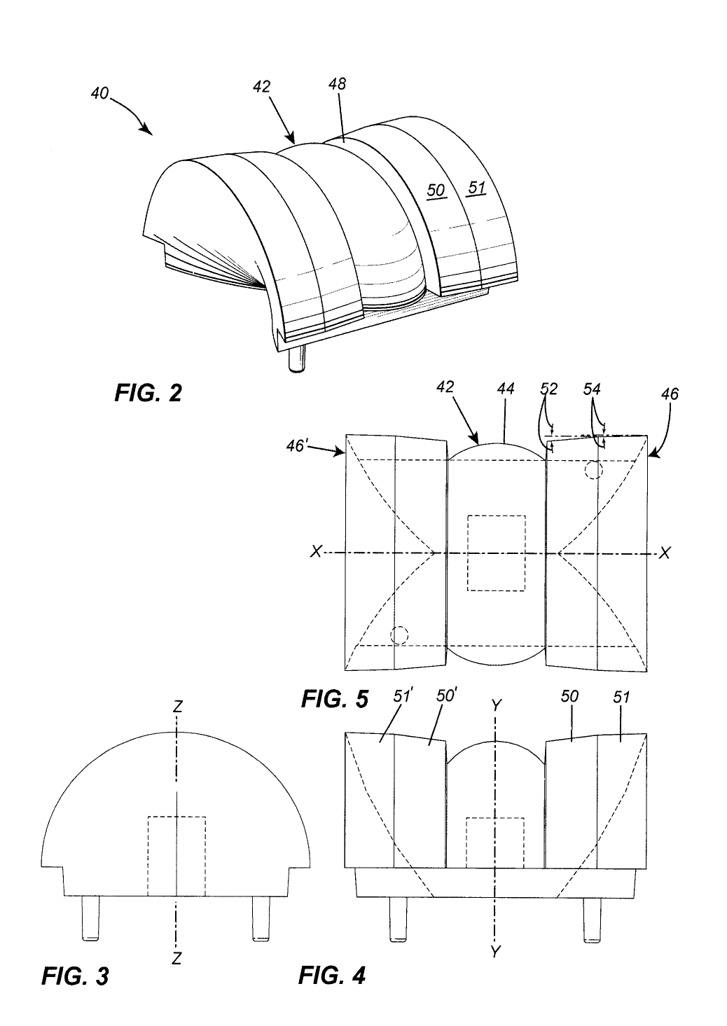

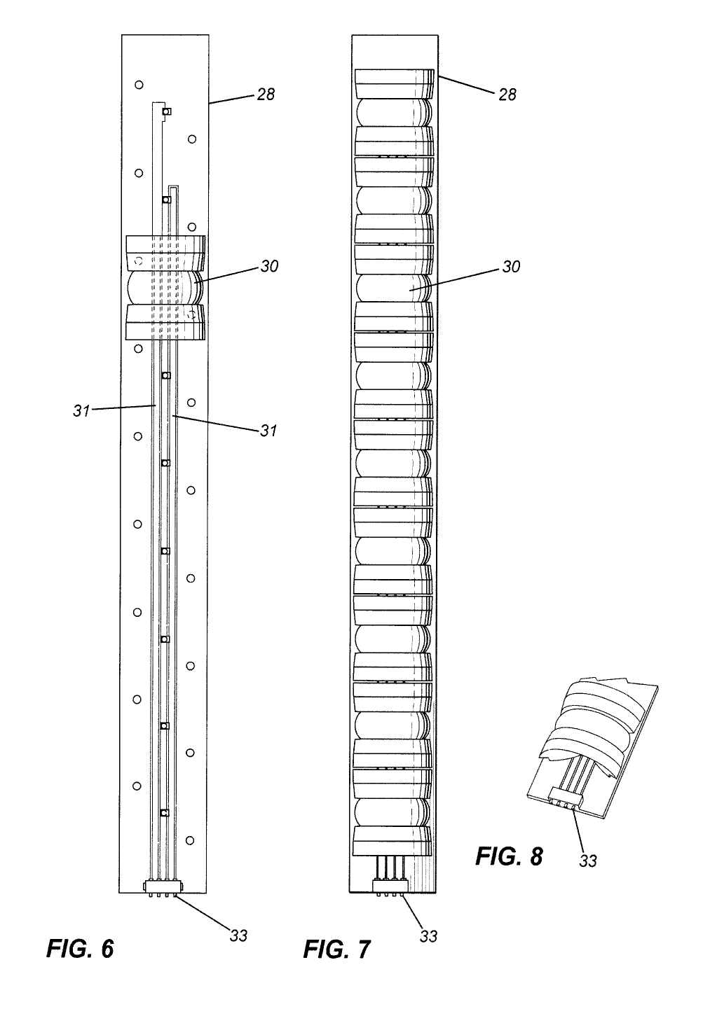

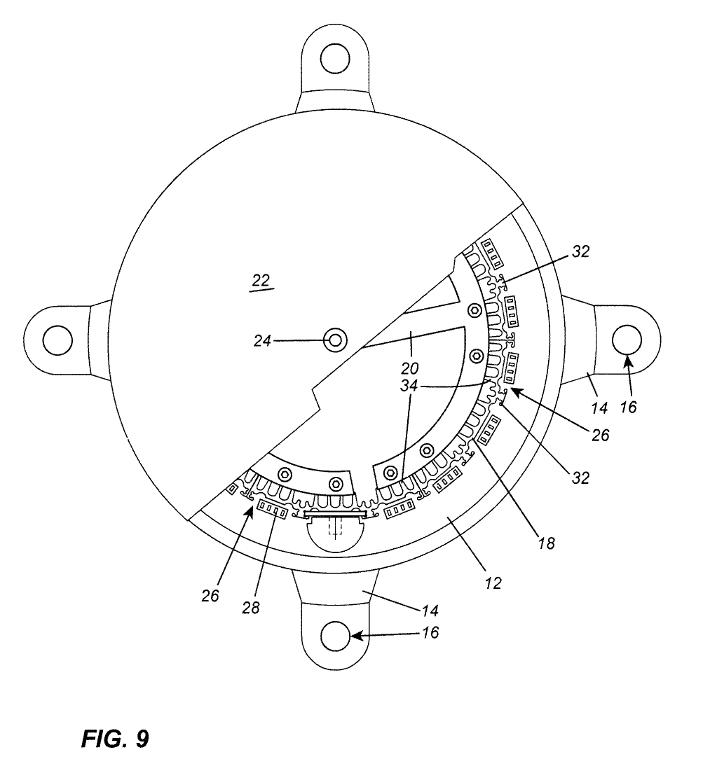

As shown in FIGS. 2 to 5, each lens 40 has a central portion 42 having an upper surface 44 which is of a convex configuration along the X axis and a semi-circular configuration along the Y axis. There are provided a first side portion 46 and a second side portion 46′. As side portions 46, 46′ are substantial mirror images of each other, only one will be described in detail herein.

First side portion 46 includes an upwardly extending side wall 48 which is substantially perpendicular to central portion 42 at the point of joinder. First side portion 46 has a first top wall segment 50 which as indicated by arrows 52, forms an angle with the horizontal plane. Preferably, this angle is in the range of approximately 8°. A second top wall segment 51 adjoining first side wall segment 50 is angled with respect to the horizontal, but at a lesser angle than first top wall segment 50. Preferably, this angle would be in the area of approximately 2° as indicated by arrows 54.

I claim:

1. A beacon for obstruction lighting, said beacon (10) comprising:
a frame, said frame having a base (12) and a side, said side comprising a side wall (18) extending upwardly from said base (12), said side wall (18) having at least one channel (26) formed therein, a channel electric contact located proximate said channel;
a LED strip (28) having an LED electric contact (33), said LED strip (28) being inserted in said at least one channel (26), said LED electric contact being in electrical communication with said channel electric contact;
said LED strip having least one LED (30) thereon; and
a cover (22).

2. The beacon of claim 1 wherein said side wall (18) has a plurality of channels (26) formed therein, each channel having a channel electric contact, each channel being adapted to receive an LED strip (28) having an LED electric contact (33) thereon, said LED electric contacts being arranged to be in electrical communication with a respective channel electric contact.

3. The beacon of claim 2 wherein each LED strip has a plurality of LED's (30) mounted thereon.

4. The beacon of claim 3 wherein each of said LED strips (28) has LED's (30) of different colors thereon.

5. The beacon of claim 3 wherein said LED's (30) comprise red LED's and white LED's.

6. The beacon of claim 4 wherein each of said LED's strips (28) is slidingly engaged within said channel (26).

7. The beacon of claim 1 wherein said cover (22) is anodized.

8. The beacon of claim 7 wherein said cover (22) is secured to said frame (20).

9. A lens (40) for an LED utilized in a beacon, said lens having a length running in an X axis and width in a Y axis and a height in a Z axis, wherein said lens comprises:
a central portion (42), first and second side portions (46, 46′) adjacent respective first and second sides of said central portion (42);
said central portion (42) having a convex cross sectional configuration in the direction of the X axis and a semi-circular configuration in the direction of the Y axis;
said first side portion (46) being located adjacent a first side of said central portion, said first side portion having an upwardly extending wall (48) in the direction of the Z axis, said upwardly extending wall (48) being located adjacent said first side of said central portion (42);
said first side portion (46) having a first top wall segment (50) extending diagonally upwardly at a first angle (52) with respect to a horizontal plane in the X axis;
a second top wall segment (51) extending diagonally upwardly adjacent to said first top wall segment (50), said second top wall segment (51) having a second angle (54) with respect to a horizontal plane in the direction of the X axis, said second angle being less than said first angle, said second side portion being a substantial mirror image of said first side portion.
